(19) United States
(12) Patent Application Publication
(10) Pub. No.: US 2020/0122112 A1
(43) Pub. Date: Apr. 23, 2020

(54) INFRARED PROCESSING DEVICE

(71) Applicant: NGK INSULATORS, LTD., Nagoya-City (JP)

(72) Inventor: Michiro AOKI, Obu-City (JP)

(73) Assignee: NGK INSULATORS, LTD., Nagoya-City (JP)

(21) Appl. No.: 16/720,638

(22) Filed: Dec. 19, 2019

Related U.S. Application Data
(63) Continuation of application No. PCT/JP2018/025204, filed on Jul. 3, 2018.

(30) Foreign Application Priority Data
Jul. 5, 2017 (JP) 2017-131628

(51) Int. Cl. B01J 19/12; H05B 3/00; H05B 3/10; H05B 3/44

(52) U.S. Cl. CPC B01J 19/12; H05B 3/009; B01J 2219/12; H05B 3/44; H05B 3/10

(57) ABSTRACT

An infrared processing device includes an infrared heater including a heating body and a metamaterial structure capable of, when thermal energy is input from the heating body, radiating infrared rays which have a maximum peak of a non-Planck distribution and whose maximum peak has a peak wavelength of 2 μm or more and 7 μm or less; an inner tube that surrounds the infrared heater, contains at least one of a fluorine-based material having a C—F bond and calcium fluoride, and transmits infrared rays of the peak wavelength; and an outer tube that surrounds the inner tube and forms, between the inner tube and the outer tube, an object channel through which a processing object is allowed to flow.

### BACKGROUND OF THE INVENTION

### 1. Field of the Invention

The present invention relates to an infrared processing device.

### 2. Description of the Related Art

Known sterilizing devices have been known that include an ultraviolet lamp, a quartz glass protective tube surrounding the ultraviolet lamp, and an outer peripheral container surrounding the protective tube (e.g., PTL 1). This sterilizing device supplies ultraviolet rays to an aqueous solution flowing through a region between the protective tube and the outer peripheral container to sterilize the aqueous solution.

### CITATION LIST

### Patent Literature

PTL 1: Japanese Unexamined Patent Application Publication No. 2008-168212

### SUMMARY OF THE INVENTION

The inventor has considered that when the infrared processing of a processing object is performed by radiating infrared rays, the above-described sterilizing device using ultraviolet rays can be used. However, quartz glass is used for the protective tube in PTL 1. Since quartz glass absorbs infrared rays having a wavelength of more than 3.5 μm, quartz glass is sometimes not suitable for the infrared processing.

To address such a problem, it is a main object of the present invention to efficiently perform the infrared processing of a processing object.

To achieve the above main object, the following device is employed in the present invention.

An infrared processing device of the present invention includes:

an infrared heater including a heating body and a metamaterial structure capable of, when thermal energy is input from the heating body, radiating infrared rays which have a maximum peak of a non-Planck distribution and whose maximum peak has a peak wavelength of 2 μm or more and 7 μm or less;

an inner tube that surrounds the infrared heater, contains at least one of a fluorine-based material having a C—F bond and calcium fluoride, and transmits infrared rays of the peak wavelength; and

an outer tube that surrounds the inner tube and forms, between the inner tube and the outer tube, an object channel through which a processing object is allowed to flow.

In this infrared processing device, the infrared heater including a metamaterial structure irradiates infrared rays which have a maximum peak of a non-Planck distribution and whose maximum peak has a peak wavelength of 2 μm or more and 7 μm or less. Through application of the infrared rays to a processing object flowing through the object channel, the infrared processing device performs the infrared processing of the processing object. The inner tube disposed between the infrared heater and the object channel contains at least one of a fluorine-based material having a C—F bond and calcium fluoride and transmits the infrared rays having a peak wavelength of the maximum peak. Since the C—F bond has no absorption peak of infrared rays in the wavelength range of about 2 μm to 7 μm, the fluorine-based material having a C—F bond has a relatively low absorptivity of the infrared rays having a peak wavelength of the maximum peak. Since the calcium fluoride has a relatively high transmittance of infrared rays in the wavelength range of 2 μm to 7 μm, the absorptivity of the infrared rays having a peak wavelength of the maximum peak is relatively low. Therefore, the inner tube does not readily prevent infrared rays having a wavelength near the maximum peak from reaching the processing object. Accordingly, this infrared processing device can efficiently perform the infrared processing of the processing object. Herein, the “infrared processing” includes any processing, such as heating processing or processing for chemical reaction, as long as a processing object is processed using infrared rays. The “processing object” may be any object that can flow through the object channel and is basically a fluid. The processing object may be a liquid or a gas. The processing object may be a fluid (liquid or gas) containing solid particles as long as the object can flow through the object channel.

In the infrared processing device according to the present invention, the inner tube includes an infrared transmitting member that transmits infrared rays of the peak wavelength, and the infrared transmitting member may contain at least one of a fluorine-based material having a C—F bond and calcium fluoride. That is, in the infrared processing device according to the present invention, the entire inner tube does not necessarily contain at least one of a fluorine-based material having a C—F bond and calcium fluoride, and a part of the inner tube may contain at least one of a fluorine-based material having a C—F bond and calcium fluoride.

In the infrared processing device according to the present invention, the inner tube may contain the fluorine-based material having a C—F bond as a main component. The inner tube may be constituted by the fluorine-based material having a C—F bond and unavoidable impurities. The inner tube may be constituted by only the fluorine-based material having a C—F bond. For the inner tube, the transmittance of infrared rays having a peak wavelength of the maximum peak and radiated from the metamaterial structure is preferably 75% or more, more preferably 80% or more, further preferably 85% or more, and still further preferably 90% or more.

In the infrared processing device according to the present invention, the fluorine-based material having a C—F bond may be a fluorocarbon resin. The fluorocarbon resin may have an ether bond or may have no ether bond. The fluorocarbon resin may have no atom other than C, F, H, and O, may have no atom other than C, F, and H, or may have no atom other than C and F. Specific examples of the fluorocarbon resin include polytetrafluoroethylene (PTFE), perfluoroalkyl vinyl ether copolymer (PFA), hexafluoropropylene copolymer (FEP), and ethylene-ethylene tetrafluoride copolymer (ethylene-tetrafluoroethylene copolymer, ETFE).

The infrared processing device according to the present invention includes a reflecting body that is disposed on an outer side of the outer tube with respect to the heating body and reflects infrared rays of the peak wavelength, and the outer tube may transmit infrared rays of the peak wavelength. This can achieve a more efficient infrared processing because the reflecting body reflects, toward the processing object, infrared rays having a peak wavelength that have been radiated from the infrared heater and have passed through the inner tube, the processing object, and the outer tube. In this case, the reflecting body may be disposed on the outer peripheral surface of the outer tube.

In the infrared processing device according to the present invention, at least part of an inner peripheral surface of the outer tube may be a reflecting surface that reflects infrared rays of the peak wavelength or the outer tube may include a reflecting body that reflects infrared rays of the peak wavelength on at least part of the inner peripheral surface. This can achieve a more efficient infrared processing because the outer tube reflects, toward the processing object, infrared rays having a peak wavelength that have been radiated from the infrared heater and have passed through the inner tube and the processing object.

In the infrared processing device according to the present invention, in the inner tube, the pressure of an internal space in which the heating body is disposed may be reducible. Thus, by performing the infrared processing while the pressure of the internal space is reduced, the amount of convective heat transfer from the infrared heater into the internal space is decreased compared with, for example, the case where the internal space has normal pressure, which can suppress the convection loss. Therefore, the infrared processing can be more efficiently performed.

The infrared processing device according to the present invention includes a transmission tube that is disposed inside the outer tube, surrounds the inner tube, contains at least one of a fluorine-based material having a C—F bond and calcium fluoride, and transmits infrared rays of the peak wavelength. The object channel may be formed between the transmission tube and the outer tube, and a coolant channel through which a coolant is allowed to flow may be formed between the inner tube and the transmission tube. Thus, by causing a coolant to flow through the coolant channel, the overheating of at least one of the processing object, the inner tube, and the transmission tube can be suppressed.

In the infrared processing device according to the present invention, the peak wavelength of the maximum peak may be more than 3.5 μm and 7 μm or less. When the peak wavelength of the maximum peak of infrared rays radiated from the metamaterial structure is more than 3.5 μm, the infrared processing cannot be efficiently performed if, for example, quartz glass is used for the inner tube. Therefore, it is significant to use the fluorine-based material having a C—F bond for the inner tube. In this case, the peak wavelength of the maximum peak may be 4 μm or more, 5 μm or more, or 6 μm or more. The peak wavelength of the maximum peak may be 6 μm or less or 5 μm or less.

In the infrared processing device according to the present invention, the metamaterial structure may include, in sequence from the heating body, a first conductor layer, a dielectric layer joined to the first conductor layer, and a second conductor layer having a plurality of individual conductor layers that are each joined to the dielectric layer and are periodically disposed so as to be away from each other.

In the infrared processing device according to the present invention, the metamaterial structure may include a plurality of microcavities in which at least the surface is made of a conductor and which are periodically disposed so as to be away from each other.

### BRIEF DESCRIPTION OF THE DRAWINGS

FIG. 1 illustrates an infrared processing device 10.

FIG. 2 is a sectional view taken along line A-A in FIG. 1.

FIG. 3 is a partial bottom view of a first metamaterial structure 30a.

FIG. 4 is a graph illustrating an example of an infrared transmission spectrum of polytetrafluoroethylene (PTFE).

FIG. 5 is a sectional view of an infrared processing device 110 according to a modification.

FIG. 6 is a sectional view of an infrared processing device 210 according to a modification.

FIG. 7 is a sectional view of an infrared processing device 310 according to a modification.

FIG. 8 is a partial sectional view of an infrared heater 20 according to a modification.

FIG. 9 is a partial bottom perspective view of a first metamaterial structure 430a according to a modification.

FIG. 10 is a graph illustrating an infrared transmission spectrum of a polytetrafluoroethylene (PTFE) film.

FIG. 11 is a graph illustrating an infrared transmission spectrum of a perfluoroalkoxyalkane (PFA) film.

FIG. 12 is a graph illustrating the radiant intensity of infrared rays that have been radiated from a radiative heater and have passed through the PTFE film.

FIG. 13 is a graph illustrating the radiant intensity of infrared rays that have been radiated from a radiative heater and have passed through the PFA film.

FIG. 14 is a graph illustrating the radiant intensity of infrared rays that have been radiated from a radiative heater and have passed through a polyethylene terephthalate (PET) film.

FIG. 15 is a graph illustrating the radiant intensity of infrared rays that have been radiated from a radiative heater and have passed through a polyimide (PI) film.

FIG. 16 illustrates an infrared processing device 510 according to a modification.

FIG. 17 is a sectional view taken along line B-B in FIG. 16.

### DETAILED DESCRIPTION OF THE INVENTION

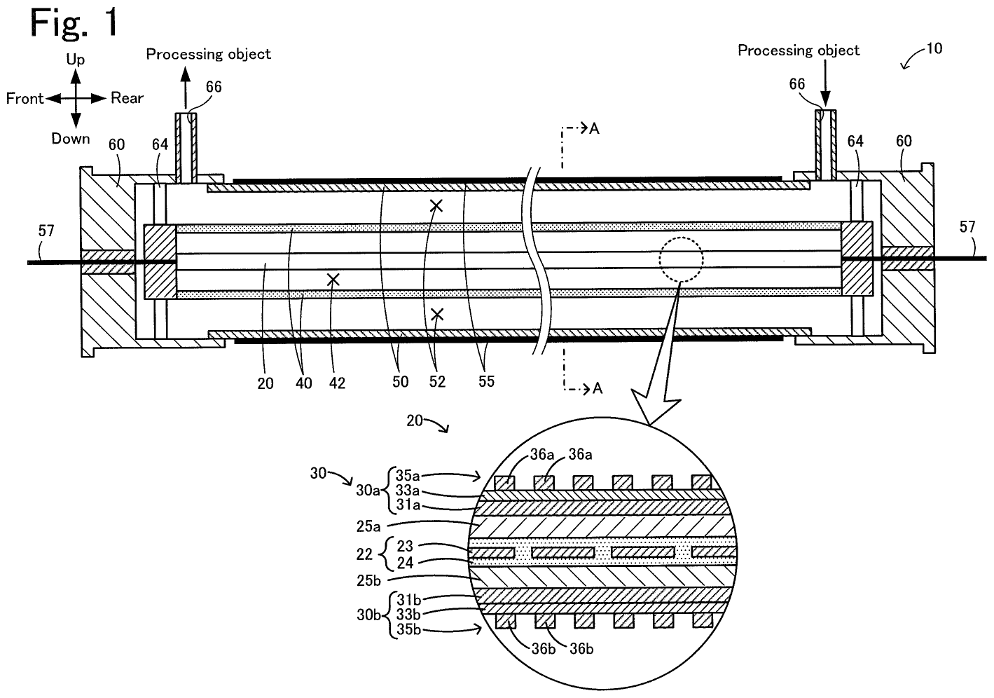

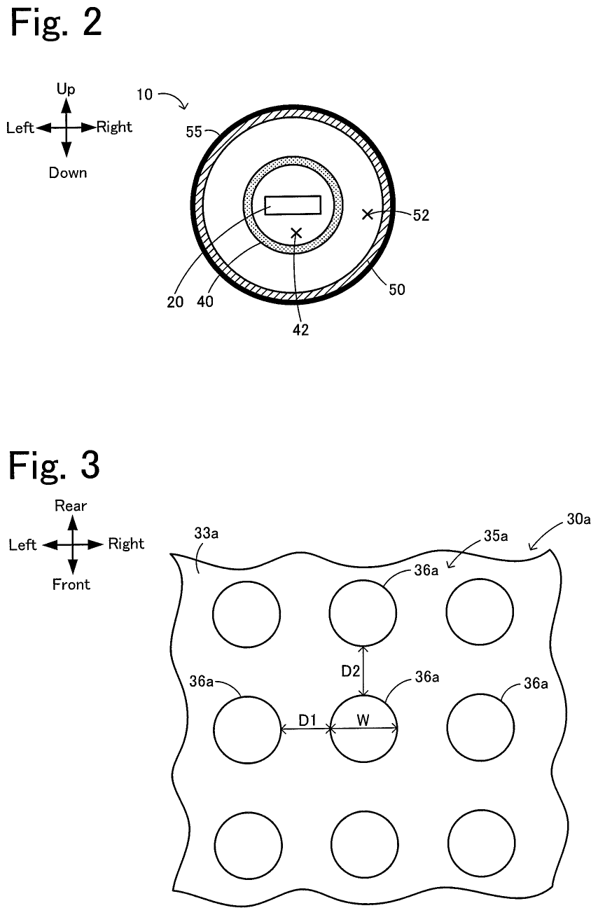

Next, an embodiment of the present invention will be described with reference to the attached drawings. FIG. 1 illustrates an infrared processing device 10 according to an embodiment of the present invention. FIG. 2 is a sectional view taken along line A-A in FIG. 1. FIG. 3 is a partial bottom view of a first metamaterial structure 30a. In this embodiment, the up and down direction, the left and right direction, and the front and rear direction are as illustrated in FIGS. 1 to 3.

The infrared processing device 10 includes an infrared heater 20, an inner tube 40 that surrounds the infrared heater 20, an outer tube 50 that surrounds the inner tube 40, a reflecting body 55 disposed on the outer peripheral surface of the outer tube 50, and cylindrical caps 60 having a closed bottom and hermetically fitted to the front and rear ends of the outer tube 50. The infrared processing device 10 has an internal space 42 formed inside the inner tube 40 and an object channel 52 formed between the inner tube 40 and the outer tube 50. The infrared processing device 10 performs infrared processing of a processing object by applying infrared rays from the infrared heater 20 to the processing object flowing through the object channel 52.

The infrared heater 20 is disposed in the internal space 42 of the inner tube 40. The infrared heater 20 has a substantially rectangular parallelepiped shape whose longitudinal direction is parallel to the front and rear direction in this embodiment. As illustrated in an enlarged view of FIG. 1, the infrared heater 20 includes a heating unit 22, first and second supporting substrates 25a and 25b respectively disposed above and below the heating unit 22, and a metamaterial structure 30 including first and second metamaterial structures 30a and 30b.

The heating unit 22 constitutes a so-called planar heater and has a flat-plate shape whose longitudinal direction is parallel to the front and rear direction. The heating unit 22 includes a heating body 23 obtained by bending a linear member in a zigzag manner and a protective member 24 that is an insulator covering the heating body 23 so as to be in contact with the heating body 23. The heating body 23 is made of, for example, W, Mo, Ta, an Fe—Cr—Al alloy, or a Ni—Cr alloy. The protective member 24 is made of, for example, an insulating resin such as polyimide or a ceramic. A pair of electric wiring lines 57 are attached to both ends of the heating body 23. The electric wiring lines 57 are hermetically extended to the outside of the infrared processing device 10 through the caps 60 and are connected to a power supply (not illustrated). The heating unit 22 may be a planar heater obtained by winding a ribbon-shaped heating body around an insulator. The heating body 23 may extend in a straight line in the longitudinal direction (herein, in the front and rear direction) of the infrared heater 20 without being bent in a zigzag manner.

The first supporting substrate 25a is a flat plate-shaped member disposed on the upper side of the heating unit 22. The first supporting substrate 25a is made of a material whose smooth surface is easily maintained and which has high heat resistance and low heat warpage, such as a Si wafer or glass. In this embodiment, a Si wafer is employed as the first supporting substrate 25a. The first supporting substrate 25a may be in contact with the upper surface of the heating unit 22 as in this embodiment or may be disposed above and below the heating unit 22 so as to be away from the heating unit 22 in a noncontact manner. When the first supporting substrate 25a and the heating unit 22 are in contact with each other, they may be joined to each other. The second supporting substrate 25b is the same as the first supporting substrate 25a, except that the second supporting substrate 25b is disposed on the lower side of the heating unit 22, and thus the detailed description thereof is omitted.

The metamaterial structure 30 includes a plate-shaped first metamaterial structure 30a disposed above the heating body 23 and the first supporting substrate 25a and a plate-shaped second metamaterial structure 30b disposed below the heating body 23 and the second supporting substrate 25b. The first and second metamaterial structures 30a and 30b may be directly joined to the first and second supporting substrates 25a and 25b or may be joined to the first and second supporting substrates 25a and 25b with an adhesive layer (not illustrated) disposed therebetween. The first metamaterial structure 30a includes a first conductor layer 31a, a dielectric layer 33a, and a second conductor layer 35a having a plurality of individual conductor layers 36a in this order in an upward direction from the heating body 23. The layers of the first metamaterial structure 30a may be directly joined to each other or may be joined to each other with an adhesive layer disposed therebetween. The upper exposed portions of the individual conductor layers 36a and the dielectric layer 33a may be covered with an antioxidant layer (not illustrated, formed of alumina, for example). The second metamaterial structure 30b includes a first conductor layer 31b, a dielectric layer 33b, and a second conductor layer 35b having a plurality of individual conductor layers 36b in this order in a downward direction from the heating body 23. The first metamaterial structure 30a and the second metamaterial structure 30b are disposed so as to be symmetrical about the heating body 23 in the up and down direction and have the same structure. Therefore, only the constituent elements of the first metamaterial structure 30a will be described hereafter.

The first conductor layer 31a is a flat plate-shaped member joined at a side (upper side) of the first supporting substrate 25a opposite to the heating body 23. The first conductor layer 31a is made of a conductor (electric conductor) such as a metal. Specific examples of the metal include gold, aluminum (Al), and molybdenum (Mo). In this embodiment, the first conductor layer 31a is made of gold. The first conductor layer 31a is joined to the first supporting substrate 25a with an adhesive layer (not illustrated) disposed therebetween. The adhesive layer is made of, for example, chromium (Cr), titanium (Ti), or ruthenium (Ru). The first conductor layer 31a and the first supporting substrate 25a may be directly joined to each other.

The dielectric layer 33a is a flat plate-shaped member joined at a side (upper side) of the first conductor layer 31a opposite to the heating body 23. The dielectric layer 33a is sandwiched between the first conductor layer 31a and the second conductor layer 35a. The dielectric layer 33a is made of, for example, alumina (Al₂O₃) or silica (SiO₂). In this embodiment, the dielectric layer 33a is made of alumina.

The second conductor layer 35a is a layer made of a conductor and has a periodic structure in directions (the front and rear direction and the left and right direction) that extend along the upper surface of the dielectric layer 33a. Specifically, the second conductor layer 35a has a plurality of individual conductor layers 36a, and the periodic structure is formed by disposing the individual conductor layers 36a in directions (the front and rear direction and the left and right direction) that extend along the upper surface of the dielectric layer 33a so as to be away from each other (refer to FIG. 3). The plurality of individual conductor layers 36a are disposed in the left and right direction (first direction) at a regular distance D1. The plurality of individual conductor layers 36a are disposed in the front and rear direction (second direction) perpendicular to the left and right direction at a regular distance D2. The individual conductor layers 36a are arranged in such a lattice pattern. In this embodiment, the individual conductor layers 36a are arranged in a tetragonal lattice pattern as illustrated in FIG. 3, but may be arranged in a hexagonal lattice pattern in which, for example, each of the individual conductor layers 36a is positioned at the vertex of a regular triangle. Each of the plurality of individual conductor layers 36a has a circular shape in top view and has a columnar shape whose thickness h (height in the up and down direction) is smaller than the diameter W. The periodic structure of the second conductor layer 35a has a lateral period of Λ1=D1+W and a longitudinal period of Λ2=D2+W. In this embodiment, D1=D2 is satisfied and thus Λ1=Λ2 is satisfied. The second conductor layer 35a (individual conductor layers 36a) is made of a conductor such as a metal, and the same material as that for the first conductor layer 31a can be employed. At least one of the first conductor layer 31a and the second conductor layer 35a may be made of a metal. In this embodiment, the second conductor layer 35a is made of gold, which is the same as the first conductor layer 31a.

As described above, the first metamaterial structure 30a includes the first conductor layer 31a, the second conductor layer 35a (individual conductor layers 36a) having a periodic structure, and the dielectric layer 33a sandwiched between the first conductor layer 31a and the second conductor layer 35a. This allows the first metamaterial structure 30a to radiate infrared rays having a maximum peak of the non-Planck distribution when thermal energy is input from the heating body 23. The Planck distribution refers to a convex distribution having a particular peak and has a curve having a steep slope on the left side of the peak and a gentle slope on the right side of the peak on a graph in which the horizontal axis indicates a wavelength that increases to the right and the vertical axis indicates a radiation intensity. Typical materials undergo radiation in accordance with this curve (Planck radiation curve). The non-Planck radiation (radiation of infrared rays having a maximum peak of the non-Planck distribution) refers to radiation whose convex slope having a maximum peak at the center is steeper than that of the Planck radiation. That is, the first metamaterial structure 30a has radiation characteristics in which the maximum peak is sharper than the peak of the Planck distribution. Herein, the phrase “sharper than the peak of the Planck distribution” refers to “the full width at half maximum (FWHM) is smaller than that of the peak of the Planck distribution”. Thus, the first metamaterial structure 30a functions as a metamaterial emitter having a characteristic of selectively radiating infrared rays having a particular wavelength in the entire wavelength range of infrared rays (0.7 μm to 1000 μm). This characteristic is believed to be due to a resonance phenomenon explained by magnetic polariton. The magnetic polariton is a resonance phenomenon in which antiparallel currents are excited between two upper and lower conductors (the first conductor layer 31a and the second conductor layer 35a, which provides a strong magnetic field confinement effect in a dielectric (the dielectric layer 33a) between the two conductors. Thus, in the first metamaterial structure 30a, a locally strong electric field oscillation is excited at the first conductor layer 31a and the individual conductor layers 36a. This serves as a radiation source of infrared rays and the infrared rays are radiated to the ambient environment (in particular, to the above). Furthermore, in this first metamaterial structure 30a, the resonant wavelength can be controlled by adjusting the materials for the first conductor layer 31a, the dielectric layer 33a, and the second conductor layer 35a and the shape and periodic structure of the individual conductor layers 36a. Thus, the infrared rays radiated from the first conductor layer 31a and the individual conductor layers 36a of the first metamaterial structure 30a achieve a high emissivity of infrared rays having a particular wavelength. That is, the first metamaterial structure 30a has a characteristic of radiating infrared rays having a sharp maximum peak whose full width at half maximum is relatively small and whose emissivity is relatively high. In this embodiment, D1=D2 is satisfied, but the distance D1 and the distance D2 may be different from each other. The same applies to the period Λ1 and the period Λ2. The full width at half maximum can be controlled by changing the period Λ1 and the period Λ2.

In the first and second metamaterial structures 30a and 30b, the resonant wavelength is controlled so that the above-described peak wavelength of the maximum peak in the particular radiation characteristic is in the range of 2 μm or more and 7 μm or less. The peak wavelength may be in the range of more than 3.5 μm and 7 μm or less. The peak wavelength may be 4 μm or more, 5 μm or more, or 6 μm or more. The peak wavelength may be 6 μm or less or 5 μm or less. The peak wavelength may be in the range of 2.5 μm or more and 3.5 μm or less, 4.5 μm or more and 5.5 μm or less, or 5.5 μm or more and 6.5 μm or less. In each of the first and second metamaterial structures 30a and 30b, the emissivity of infrared rays is preferably 0.2 or less in a wavelength range other than the wavelength range from the rising edge to the falling edge of the maximum peak. In each of the first and second metamaterial structures 30a and 30b, the full width at half maximum of the maximum peak is preferably 1.0 μm or less. The radiation characteristics of the first and second metamaterial structures 30a and 30b may have a shape substantially symmetrical about the maximum peak in the left and right direction. The height (maximum radiation intensity) of the maximum peak in the first and second metamaterial structures 30a and 30b is lower than that of the above-described Planck radiation curve. The peak wavelength of the maximum peak of infrared rays radiated from the metamaterial structure 30 is measured as follows. First, light from a light source of an FT-IR instrument (Fourier transform infrared spectrophotometer) is vertically incident on the metamaterial structure 30, and the reflected light is measured using an integrating sphere to determine the hemispherical reflectance of the metamaterial structure 30. The hemispherical reflectance of a gold plate (reflectance 0.95) measured by the same method is used as a background. Then, the reflection spectrum of the metamaterial structure 30 is determined by comparing the hemispherical reflectance of the metamaterial structure 30 and the background. The bottom wavelength (the wavelength at a valley at which the reflectance is minimum) in the determined reflection spectrum is defined as a peak wavelength of the maximum peak of infrared rays radiated from the metamaterial structure 30.

The first metamaterial structure 30a can be formed by, for example, the following method. First, an adhesive layer and a first conductor layer 31a are formed on a surface (upper surface in FIG. 1) of a first supporting substrate 25a in this order. Then, a dielectric layer 33a is formed on a surface (upper surface in FIG. 1) of the first conductor layer 31a by an ALD (atomic layer deposition) method. Subsequently, a particular resist pattern is formed on a surface (upper surface in FIG. 1) of the dielectric layer 33a and then a layer made of a material for the second conductor layer 35a is formed by a helicon sputtering method. By removing the resist pattern, a second conductor layer 35a (a plurality of individual conductor layers 36a) is formed. The constituent elements of the first metamaterial structure 30a and the corresponding constituent elements of the second metamaterial structure 30b may be made of the same material or may be partly different from each other.

The inner tube 40 is a tubular member that surrounds the infrared heater 20, and is a cylindrical member in this embodiment. The infrared heater 20 is disposed in the internal space 42 formed inside the inner tube 40. The internal space 42 is formed so as not to communicate with the object channel 52 inside the outer tube 50. In this embodiment, the internal space 42 is sealed.

The internal space 42 is preferably allowed to have a reduced-pressure state at least during operation of the infrared processing device 10. In this embodiment, the internal space 42 is sealed from the outside space while the atmosphere is set to an air atmosphere and a reduced-pressure atmosphere in advance. The internal space 42 may be in an inert gas atmosphere. The internal space 42 may be in a normal-pressure atmosphere without reducing the pressure. The pressure of the internal space 42 in a reduced-pressure state may be 100 Pa or less. The pressure of the internal space 42 in a reduced-pressure state may be 0.01 Pa or more. Both the inner tube 40 and the infrared heater 20 may be integrally fixed to each other at both ends in the longitudinal direction. In this case, the inner tube 40 and the infrared heater 20 may be integrally exchangeable by removing the caps 60.

The inner tube 40 contains a fluorine-based material having a C—F bond. The inner tube 40 transmits infrared rays having a peak wavelength of the maximum peak and radiated from the metamaterial structure 30. The C—F bond has an absorption peak of infrared rays at a wavelength of about 8 μm, but has no absorption peak of infrared rays at a wavelength of about 2 μm to 7 μm. Therefore, the fluorine-based material having a C—F bond has a relatively low absorptivity of infrared rays having a peak wavelength of the maximum peak and radiated from the metamaterial structure 30. Thus, the inner tube 40 does not readily prevent infrared rays having a wavelength near the maximum peak from reaching the processing object. The inner tube 40 may contain a fluorine-based material having a C—F bond as a main component. The main component refers to a component having the highest content, such as a component having the highest mass content. The inner tube 40 may be constituted by the fluorine-based material having a C—F bond and unavoidable impurities. The inner tube 40 may be constituted by only the fluorine-based material having a C—F bond. The inner tube 40 may contain only one fluorine-based material having a C—F bond or two or more fluorine-based materials having a C—F bond. The fluorine-based material having a C—F bond may be a fluorocarbon resin. The fluorine-based material having a C—F bond may have an ether bond or may have no ether bond. The fluorine-based material having a C—F bond may have no atom other than C, F, H, and O, may have no atom other than C, F, and H, or may have no atom other than C and F. The inner tube 40 is preferably made of a material having a small number of bonds that have an absorption peak of infrared rays near the maximum peak of the metamaterial structure 30. For example, an O—H bond and a N—H bond have an absorption peak at a wavelength of 2.8 μm to 3.2 μm. Therefore, when the peak wavelength of the maximum peak of infrared rays radiated from the metamaterial structure 30 is about 2.8 μm to 3.2 μm (e.g., 2.5 μm or more and 3.5 μm or less), a material in which the number of at least one of the O—H bond and the N—H bond is small is preferably used, and a material having neither of the O—H bond nor the N—H bond is more preferably used. Specific examples of the fluorocarbon resin include polytetrafluoroethylene (PTFE), perfluoroalkyl vinyl ether copolymer (PFA), hexafluoropropylene copolymer (FEP), and ethylene-ethylene tetrafluoride copolymer (ethylene-tetrafluoroethylene copolymer, ETFE). In this embodiment, the inner tube 40 is made of polytetrafluoroethylene (PTFE). The heat resistance of the inner tube 40 is dependent on the temperature of a processing object that flows through the object channel 52, but may be, for example, 100° C. or higher and is preferably 200° C. or higher. Among the specific examples of the fluorocarbon resin, PTFE or PFA is preferred from the viewpoint of heat resistance.

For the inner tube 40, the transmittance of infrared rays having a peak wavelength of the maximum peak and radiated from the metamaterial structure 30 is preferably 75% or more, more preferably 80% or more, further preferably 85% or more, and still further preferably 90% or more. For the inner tube 40, the transmittance of infrared rays having any wavelength in the range of the full width at half maximum of the maximum peak and radiated from the metamaterial structure 30 is also preferably 75% or more, more preferably 80% or more, and further preferably 90% or more. The inner tube 40 may transmit infrared rays at any wavelength in the wavelength range of 2 μm or more and 7 μm or less. For the inner tube 40, the transmittance of infrared rays at any wavelength in the wavelength range of 2 μm or more and 7 μm or less may be 75% or more. The inner tube 40 may transmit infrared rays at any wavelength in the wavelength range of more than 3.5 μm and 7 μm or less, and the transmittance may be 75% or more. The inner tube 40 may transmit infrared rays at any wavelength in the wavelength range of 5 μm or more and 7 μm or less, and the transmittance may be 75% or more.

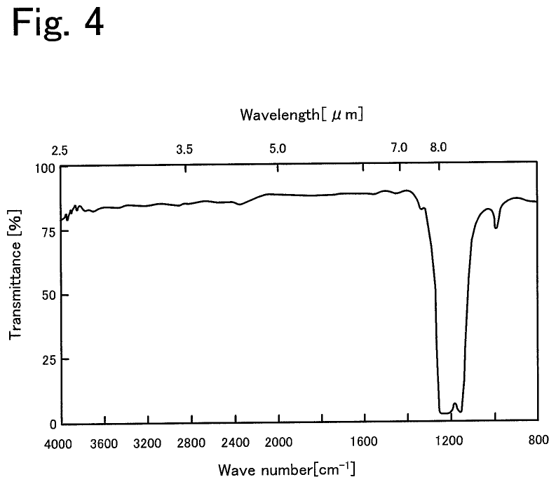

FIG. 4 is a graph illustrating an example of an infrared transmission spectrum of polytetrafluoroethylene (PTFE) that is a material for the inner tube 40 according to this embodiment. As illustrated in FIG. 4, PTFE has a minimum infrared transmittance at about 8 μm (i.e., the absorption peak wavelength is about 8 μm), and has a relatively high transmittance of infrared rays at any wavelength in the wavelength range of 2.5 μm or more and 7 μm or less. Although not illustrated, PTFE also has a relatively high transmittance of infrared rays at any wavelength in the wavelength range of 2.0 μm or more and 2.5 μm or less. Therefore, even if the peak wavelength of the maximum peak of infrared rays radiated from the metamaterial structure 30 is any wavelength in the range of 2 μm or more and 7 μm or less, the inner tube 40 formed of polytetrafluoroethylene (PTFE) can transmit infrared rays of the peak wavelength. The spectrum illustrated in FIG. 4 is an infrared transmission spectrum of polytetrafluoroethylene (PTFE), and the transmittance of an actual infrared transmission spectrum of the inner tube 40 varies depending on, for example, the thickness of the inner tube 40. The thickness of the inner tube 40 may be, for example, 0.5 mm or more and 3 mm or less. The transmittance of the inner tube 40 is a value measured based on an infrared transmission spectrum of a flat plate-shaped sample (50 mm×50 mm) made of the same material and having the same thickness as the inner tube 40, the spectrum being obtained using an FT-IR instrument (Fourier transform infrared spectrophotometer). The thickness of the inner tube 40 may be, for example, 0.01 mm or more and 0.5 mm or less. The thickness of the inner tube 40 may be 0.05 mm or more. The thickness of the inner tube 40 may be 0.1 mm or less.

The outer tube 50 is a tubular member that is located on the outer side of the inner tube 40 with respect to the infrared heater 20 and that surrounds the inner tube 40. In this embodiment, the outer tube 50 is a cylindrical member. The outer tube 50 is formed of a material that transmits infrared rays having a peak wavelength of the maximum peak and radiated from the metamaterial structure 30. The outer tube 50 is made of a fluorine-based material having a C—F bond as in the case of the inner tube 40. Various materials for the inner tube 40 can be used for the outer tube 50. The above description about the transmittance of infrared rays through the inner tube 40 can be applied to the outer tube 50. In this embodiment, the outer tube 50 is made of polytetrafluoroethylene (PTFE) as in the case of the inner tube 40. The object channel 52 is formed between the outer tube 50 and the inner tube 40. In this embodiment, the object channel 52 is a space surrounded by the inner peripheral surface of the outer tube 50 and the outer peripheral surface of the inner tube 40. A processing object is allowed to flow through the object channel 52.

The reflecting body 55 is disposed on the outer side of the outer tube 50 with respect to the heating body 23. In this embodiment, the reflecting body 55 is formed as a reflecting layer disposed on the outer peripheral surface of the outer tube 50. As illustrated in FIG. 2, the reflecting body 55 is disposed so as to entirely cover the outer tube 50 in a section perpendicular to the longitudinal direction of the outer tube 50. The reflecting body 55 is formed of an infrared reflecting material that reflects infrared rays having a peak wavelength of the maximum peak and radiated from the metamaterial structure 30. Examples of the infrared reflecting material include gold, platinum, and aluminum. The reflecting body 55 is formed by forming a film of the infrared reflecting material on a surface of the outer tube 50 by a film formation method such as coating and drying, sputtering, CVD, or thermal spraying.

The caps 60 are disposed on both ends of the outer tube 50 and fitted to the front and rear ends of the outer tube 50. The infrared heater 20 and the inner tube 40 have both ends supported by holders 64 disposed inside the caps 60. Thus, the caps 60 support the infrared heater 20, the inner tube 40, and the outer tube 50. The caps 60 each have object entrances 66. A processing object is supplied to one of the object entrances 66 from an object supply source (not illustrated). A processing object that has flowed into the cap 60 through one of the object entrances 66 flows through the object channel 52 and flows out through the other of the object entrances 66.

Next, the operation of the infrared processing device 10 having such configuration will be described. First, electric power is supplied to both ends of the heating body 23 through the electric wiring lines 57 from a power supply (not illustrated). A processing object is caused to flow through the object channel 52 from the object supply source. The electric power is supplied such that, for example, the temperature of the heating body 23 reaches a predetermined temperature (not particularly limited, but set to 320° C. herein). Energy is transferred to the surroundings from the heating body 23 whose temperature has reached the predetermined temperature mainly by conduction among three heat transfer mechanisms, namely, conduction, convection, and radiation, and thus the metamaterial structure 30 is heated. As a result, the temperature of the metamaterial structure 30 increases to the predetermined temperature (herein, e.g., 300° C.), and the metamaterial structure 30 serving as a radiator radiates infrared rays. At this time, when the first and second metamaterial structures 30a and 30b respectively include the first conductor layers 31a and 31b, the dielectric layers 33a and 33b, and the second conductor layers 35a and 35b as described above, the infrared heater 20 radiates infrared rays having a maximum peak of the non-Planck distribution and the peak wavelength of the maximum peak is in the range of 2 μm or more and 7 μm or less. More specifically, the infrared heater 20 selectively radiates infrared rays in a particular wavelength range (infrared rays having a peak wavelength of the maximum peak and wavelengths near the peak wavelength) from the first conductor layers 31a and 31b and the individual conductor layers 36a and 36b of the first and second metamaterial structures 30a and 30b. The infrared rays in the particular wavelength range pass through the inner tube 40 and are applied to a processing object that flows through the object channel 52. Thus, the infrared processing device 10 can selectively radiate infrared rays in the particular wavelength range onto the processing object in the object channel 52. Therefore, in the infrared processing device 10, for example, infrared rays can be efficiently applied to a processing object having a relatively high absorptivity for the infrared rays in the particular wavelength range, and thus infrared processing such as heating processing or processing for chemical reaction can be performed. Furthermore, since the inner tube 40 transmits infrared rays having a peak wavelength of the maximum peak and radiated from the metamaterial structure 30, the inner tube 40 does not readily prevent infrared rays having a wavelength near the maximum peak from reaching the processing object. This allows the infrared processing device 10 to more efficiently perform infrared processing of the processing object. Until the infrared processing is completed, the processing object may be circulated so as to continuously flow through the object channel 52 by causing the processing object that has flowed out through the other of the object entrances 66 to flow into the one of the object entrances 66 again.

An example of the infrared processing will be described. For example, when the processing object is a substance having a hydrogen bond, such as water, energy can be efficiently input to the hydrogen bond by using a metamaterial structure 30 that radiates infrared rays whose maximum peak has a peak wavelength of about 3 μm. Consequently, the processing object can be efficiently heat-processed. When the processing object is a substance having a cyano group, energy can be efficiently input to the cyano group by using a metamaterial structure 30 that radiates infrared rays whose maximum peak has a peak wavelength of about 4.8 μm. Consequently, for example, the substitution reaction of the processing object can be efficiently promoted. When the processing object is a substance having a carbonyl group, energy can be efficiently input to the carbonyl group by using a metamaterial structure 30 that radiates infrared rays whose maximum peak has a peak wavelength of about 5.9 μm. Consequently, for example, the substitution reaction of the processing object can be efficiently promoted. Although not particularly limited, the infrared processing device 10 can be used for efficiently reacting processing objects in the fields of, for example, organic synthesis and production of pharmaceuticals.

In the infrared processing device 10 according to this embodiment that has been described in detail, the infrared heater 20 including the metamaterial structure 30 radiates infrared rays which have a maximum peak of the non-Planck distribution and whose maximum peak has a peak wavelength of 2 μm or more and 7 μm or less. The inner tube 40 disposed between the infrared heater 20 and the object channel 52 contains a fluorine-based material having a C—F bond and transmits infrared rays having a peak wavelength of the maximum peak and radiated from the metamaterial structure 30. Therefore, the inner tube 40 does not readily prevent infrared rays having a wavelength near the maximum peak from reaching the processing object. Accordingly, the infrared processing device 10 can efficiently perform the infrared processing of a processing object.

The infrared processing device 10 also includes the reflecting body 55 that is disposed on the outer side of the outer tube 50 with respect to the heating body 23 and that reflects infrared rays having a peak wavelength of the maximum peak and radiated from the metamaterial structure 30. The outer tube 50 transmits infrared rays having a peak wavelength of the maximum peak. Thus, since the reflecting body 55 reflects, toward the processing object, infrared rays having a peak wavelength that have been radiated from the infrared heater 20 and have passed through the inner tube 40, the processing object, and the outer tube 50, the infrared processing device 10 can more efficiently perform the infrared processing.

Furthermore, in the inner tube 40, the pressure of the internal space 42 in which the heating body 23 is disposed is reducible. Therefore, by performing the infrared processing while the pressure of the internal space 42 is reduced, the amount of convective heat transfer from the infrared heater 20 into the internal space 42 is decreased compared with, for example, the case where the internal space 42 has normal pressure, which can suppress the convection loss. Accordingly, the infrared processing can be more efficiently performed.

Furthermore, the peak wavelength of the maximum peak of infrared rays radiated from the metamaterial structure 30 may be more than 3.5 μm and 7 μm or less. When the peak wavelength of the maximum peak of infrared rays radiated from the metamaterial structure 30 is more than 3.5 μm, the use of, for example, quartz glass as the inner tube 40 inhibits an efficient infrared processing. Therefore, it is significant to use the fluorine-based material having a C—F bond for the inner tube 40.

The present invention is not limited to the above-described embodiments, and can be carried out by various modes as long as they belong to the technical scope of the invention.

For example, in the above embodiment, the object channel 52 is a space surrounded by the inner peripheral surface of the outer tube 50 and the outer peripheral surface of the inner tube 40, but it suffices that the object channel 52 is a space between the inner tube 40 and the outer tube 50. For example, another member may be present between the inner tube 40 and the outer tube 50. FIG. 5 is a sectional view of an infrared processing device 110 according to this modification. The infrared processing device 110 includes a transmission tube 45 disposed between the inner tube 40 and the outer tube 50 so as to surround the inner tube 40. The transmission tube 45 transmits infrared rays having a peak wavelength of the maximum peak and radiated from the metamaterial structure 30 as in the case of the inner tube 40. The transmission tube 45 contains a fluorine-based material having a C—F bond. Various materials for the inner tube 40 can be used for the transmission tube 45. The above description about the transmittance of infrared rays through the inner tube 40 can be applied to the transmission tube 45. The inner tube 40 and the transmission tube 45 may be made of the same material. In the infrared processing device 110, the object channel 52 is formed as a space between the outer peripheral surface of the transmission tube 45 and the inner peripheral surface of the outer tube 50. In the infrared processing device 110, a coolant channel 47 is formed as a space surrounded by the outer peripheral surface of the inner tube 40 and the inner peripheral surface of the transmission tube 45. When both the inner tube 40 and the transmission tube 45 contain the fluorine-based material having a C—F bond and transmit infrared rays having a peak wavelength of the maximum peak and radiated from the metamaterial structure 30, the transmission tube 45 can be regarded as an “inner tube” of the infrared processing device according to the present invention. In the infrared processing device 110, by causing a coolant to flow through the coolant channel 47, overheating of at least one of the processing object, the inner tube 40, and the transmission tube 45 can be suppressed. The coolant may flow in from the outside and flow out from the coolant channel 47 through, for example, coolant entrances (not illustrated) disposed in the caps 60. The coolant caused to flow through the coolant channel 47 is preferably a material having high transmittance of infrared rays having a peak wavelength of the maximum peak and radiated from the metamaterial structure 30. For example, the coolant may be air. When the peak wavelength of the maximum peak of infrared rays radiated from the metamaterial structure 30 is, for example, 5 μm to 7 μm, the coolant may be water. When the peak wavelength of the maximum peak of infrared rays radiated from the metamaterial structure 30 is, for example, 2 μm to 5 μm, the coolant may be a liquid containing a fluorine-based material having a C—F bond. A specific example of the fluorine-based material used for the coolant is heptafluorocyclopentane.

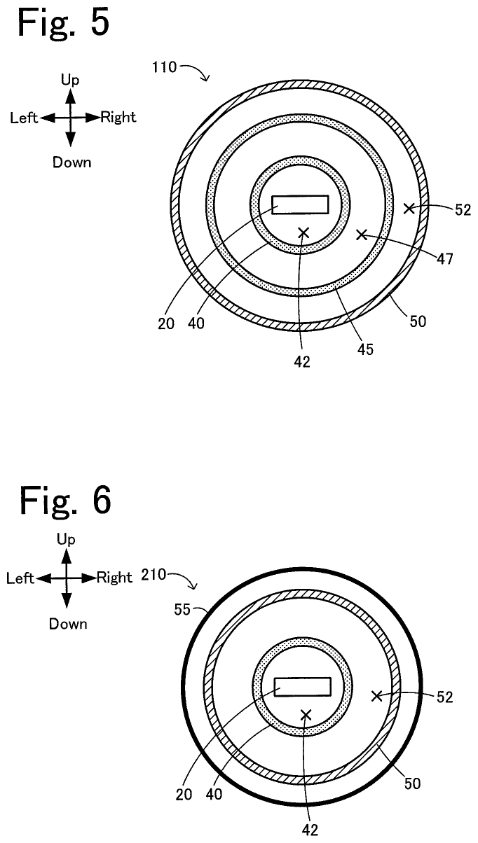

In the above embodiment, the reflecting body 55 is formed on the outer peripheral surface of the outer tube 50, but is not limited thereto. For example, as illustrated in a sectional view of an infrared processing device 210 according to a modification in FIG. 6, the reflecting body 55 may be an independent member separated from the outer tube 50.

In the above embodiment, the infrared processing device 10 does not necessarily include the reflecting body 55. In this case, the outer tube 50 may be a material that does not transmit infrared rays having a peak wavelength of the maximum peak and radiated from the metamaterial structure 30. For example, the outer tube 50 may be made of quartz glass or metal.

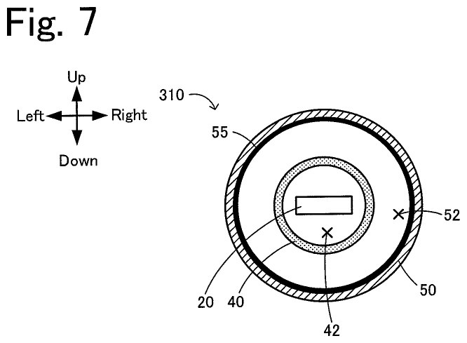

In the above embodiment, the outer tube 50 may include, on at least part of the inner peripheral surface, a reflecting body that reflects infrared rays having a peak wavelength of the maximum peak and radiated from the metamaterial structure 30. FIG. 7 is a sectional view of an infrared processing device 310 according to this modification. In this infrared processing device 310, the reflecting body 55 is formed on the inner peripheral surface of the outer tube 50, but not outside the outer tube 50. In the infrared processing device 310, the reflecting body 55 on the outer tube 50 also reflects, toward the processing object, infrared rays having a peak wavelength that have been radiated from the infrared heater 20 and have passed through the inner tube 40 and the processing object. Therefore, the infrared processing can be more efficiently performed. Instead of the case where the outer tube 50 includes the reflecting body 55 on the inner peripheral surface thereof, at least part of the inner peripheral surface of the outer tube 50 may be a reflecting surface that reflects infrared rays having a peak wavelength of the maximum peak and radiated from the metamaterial structure 30. For example, the outer tube 50 is made of metal, and the inner peripheral surface of the outer tube 50 may be polished to form a reflecting surface. In this case, the same effects as those in the infrared processing device 310 are also produced. When the outer tube 50 includes the reflecting body 55 or when the inner peripheral surface of the outer tube 50 is a reflecting surface, the outer tube 50 may be made of a material that does not transmit infrared rays having a peak wavelength of the maximum peak and radiated from the metamaterial structure 30.

In the above embodiment, the internal space 42 is sealed while the pressure is reduced in advance, but is not limited thereto. The internal space 42 may be provided such that the reduced-pressure state can be achieved during operation. For example, the pressure of the internal space 42 may be reduced during operation of the infrared processing device 10 using a vacuum pump through a pipe (not illustrated) attached to at least one of the caps 60 and the inner tube 40.

In the above embodiment, it suffices that the internal space 42 does not communicate with the object channel 52. The internal space 42 may communicate with the outside space. For example, the internal space 42 may communicate with the outside space by causing the inner tube 40 to penetrate through the caps 60 at its both ends in the front and rear direction.

In the above embodiment, the infrared heater 20 does not necessarily include at least one of the first and second supporting substrates 25a and 25b. In this case, the metamaterial structure 30 may be joined to the heating unit 22.

In the above embodiment, the metamaterial structure 30 includes the first metamaterial structure 30a that radiates infrared rays upward and the second metamaterial structure 30b that radiates infrared rays downward, but is not limited thereto. For example, one of the first and second metamaterial structures 30a and 30b may be omitted. Alternatively, the metamaterial structure 30 may include the same structure as the first metamaterial structure 30a, the structure radiating infrared rays in the left and right direction. The metamaterial structure 30 may include a first conductor layer, a dielectric layer, and a second conductor layer formed in a ring shape so as to surround the heating unit 22 in a section (e.g., a section illustrated in FIG. 2) perpendicular to the longitudinal direction of the infrared heater 20.

In the above embodiment, the case where the infrared processing of a processing object is performed using a single infrared processing device 10 has been described, but the infrared processing may be performed by combining a plurality of infrared processing devices 10. For example, two or more infrared processing devices 10 that use infrared rays having different peak wavelengths of the maximum peaks and radiated from the metamaterial structure 30 may be provided. A processing object may be caused to successively flow through the object channels 52 of the plurality of infrared processing devices 10 to perform different infrared processings on the processing object in sequence.

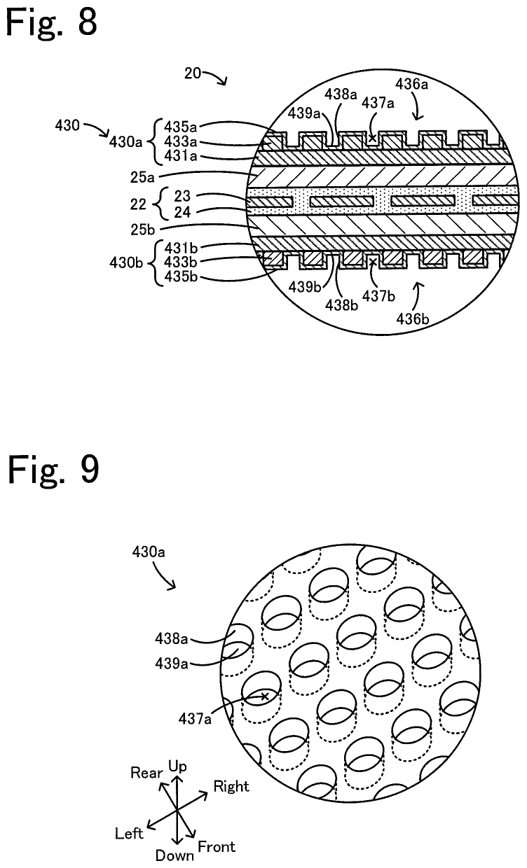

In the above embodiment, the metamaterial structure 30 includes the first conductor layer, the dielectric layer, and the second conductor layer, but is not limited thereto. It suffices that the metamaterial structure 30 is a structure capable of radiating, when thermal energy is input from the heating body 23, infrared rays which have a maximum peak of the non-Planck distribution and whose maximum peak has a peak wavelength of 2 μm or more and 7 μm or less. For example, the metamaterial structure may be provided as a microcavity-formed body having a plurality of microcavities. FIG. 8 is a partial sectional view of an infrared heater 20 according to a modification. FIG. 9 is a partial bottom perspective view of a first metamaterial structure 430a according to a modification. The infrared heater 20 in FIG. 9 includes a metamaterial structure 430 instead of the metamaterial structure 30. The metamaterial structure 430 includes a first metamaterial structure 430a disposed above the heating body 23 and a second metamaterial structure 430b disposed below the heating body 23. The first metamaterial structure 430a has a plurality of microcavities 437a in which at least the surface (herein side surface 438a and bottom surface 439a) is formed of a conductor layer 435a and which constitute a periodic structure in the front and rear direction and the left and right direction. The first metamaterial structure 430a includes a main body layer 431a, a recess-forming layer 433a, and a conductor layer 435a in this order in an upward direction from the heating body 23 of the infrared heater 20. The main body layer 431a is formed of, for example, a glass substrate. The recess-forming layer 433a is made of, for example, a resin or an inorganic material such as ceramic or glass and is formed on an upper surface of the main body layer 431a so as to have columnar recesses. The recess-forming layer 433a may be made of the same material as the above-described second conductor layers 35a and 35b. The conductor layer 435a serves as a surface (upper surface) of the first metamaterial structure 430a and covers a surface (upper surface and side surfaces) of the recess-forming layer 433a and an upper surface (a portion on which the recess-forming layer 433a is not disposed) of the main body layer 431a. The conductor layer 435a is formed of a conductor. Examples of the material for the conductor include metals such as gold and nickel and conductive resins. Each of the microcavities 437a is a substantially columnar space having an open top and surrounded by a side surface 438a (a portion that covers the side surface of the recess-forming layer 433a) and a bottom surface 439a (a portion that covers the upper surface of the main body layer 431a) of the conductor layer 435a. As illustrated in FIG. 9, the microcavities 437a are arranged in the front and rear direction and the left and right direction. The upper surface of the first metamaterial structure 430a is a radiation surface 436a from which infrared rays are radiated to an object. Specifically, when the first metamaterial structure 430a absorbs energy from the heating body 23, infrared rays having a particular wavelength are strongly radiated from the radiation surface 436a toward an object in an upward direction as a result of resonance between an incident wave and a reflected wave in a space formed by the bottom surface 439a and the side surface 438a. Thus, the first metamaterial structure 430a is allowed to radiate infrared rays which have a maximum peak of the non-Planck distribution and whose maximum peak has a peak wavelength of 2 μm or more and 7 μm or less as in the case of the first metamaterial structure 30a. The radiation characteristics of the first metamaterial structure 430a can be controlled by adjusting the diameter and depth of each of the columns of the plurality of microcavities 437a. The shape of the microcavities 437a may be a polygonal prism instead of the column. The depth of the microcavities 437a may be, for example, 1.5 μm or more and 10 μm or less. The first metamaterial structure 430a can be formed by, for example, the following method. First, a recess-forming layer 433a is formed in a portion serving as an upper surface of the main body layer 431a by a well-known nanoimprinting method. Then, the conductor layer 435a is formed by, for example, sputtering so as to cover the surface of the recess-forming layer 433a and the surface of the main body layer 431a. The second metamaterial structure 430b is the same as the first metamaterial structure 430a, except for upper and lower symmetry. Therefore, the same symbol as the constituent elements of the first metamaterial structure 430a is given for the constituent elements of the second metamaterial structure 430b, except that the suffix is changed from a to b, and the detailed description is omitted. In such an infrared processing device 10 including the infrared heater 20 according to a modification, the infrared processing of a processing object that flows through the object channel 52 can be efficiently performed as in the above embodiment.

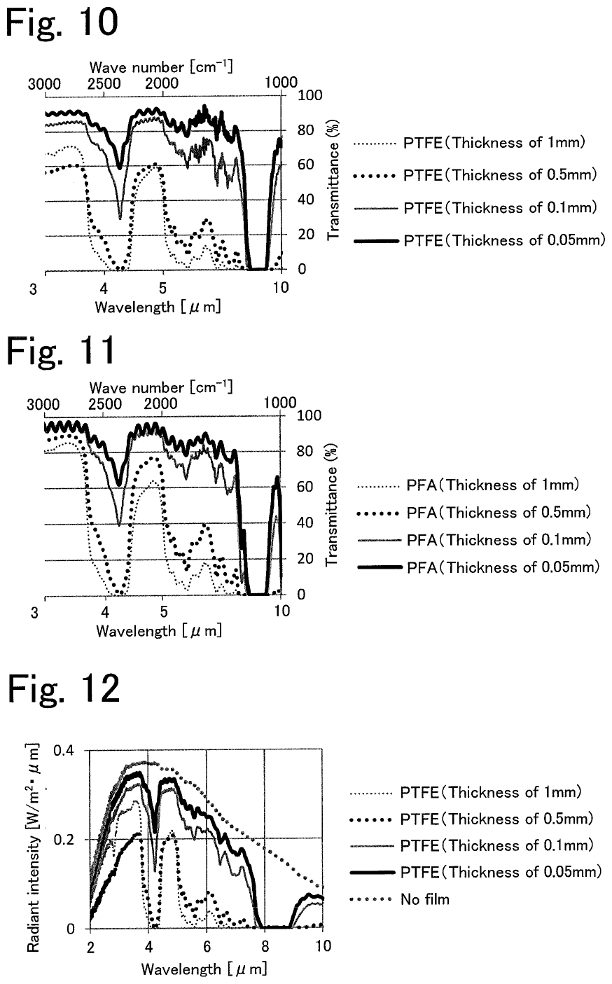

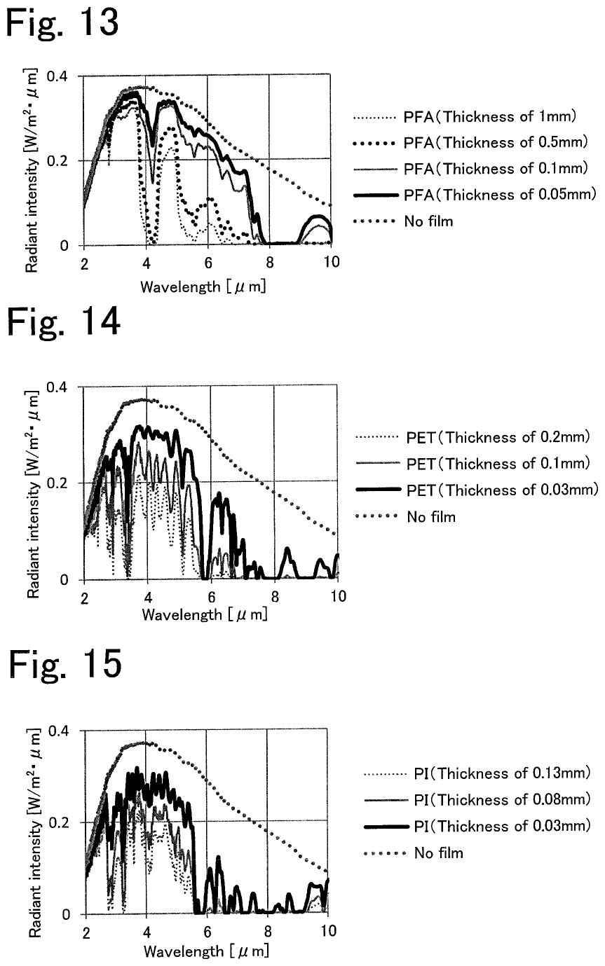

A PTFE (polytetrafluoroethylene) film and a PFA (perfluoroalkoxyalkane) film were provided as specific examples of the fluorine-based material having a C—F bond, and the transmission performance of infrared rays was evaluated for these films. Films having four thicknesses of 1.0 mm, 0.5 mm, 0.1 mm, and 0.05 mm were provided for each of the PTFE and PFA films. The measurement was performed using an FT/IR-6100 Fourier transform infrared spectrophotometer (hereafter, a spectrometer) manufactured by JASCO Corporation. First, the infrared transmission spectrum of each film was measured. Each film was cut to a size of 50 mm×50 mm and inserted into a sample chamber of the spectrometer, and measurement was performed. FIG. 10 and FIG. 11 illustrate the results. As is clear from FIGS. 10 and 11, strong absorption was observed at a wavelength of about 8 μm for each of the PTFE film and the PFA film as in the case in FIG. 4, and the transmittance of infrared rays was relatively high at any wavelength in the wavelength range of 3.3 μm or more (wave number 3000 cm⁻¹ or less) and 7 μm or less. Although not illustrated, for each of the PTFE film and the PFA film, the transmittance of infrared rays was relatively high at any wavelength in the wavelength range of 2.0 μm or more and less than 3.3 μm. However, the transmittance tended to slightly decrease in the wavelength range of more than 3.7 μm and less than 4.4 μm. For each of the PTFE film and the PFA film, the transmittance tended to increase as the thickness decreased. The decrease in the transmittance in the wavelength range of more than 3.7 μm and less than 4.4 μm is much smaller in FIG. 4 than in FIG. 10. This is because the PTFE film in FIG. 4 is thinner than that in FIG. 10. Next, the radiant intensity of infrared rays that were radiated from a radiative heater not including a metamaterial structure and passed through the above film was measured. First, an optional external light-introducing unit was attached to the above spectrometer. The internal radiation of a blackbody furnace MODEL LS1215 100 manufactured by JASCO Corporation and uniformly heated at 1000° C. was introduced into the spectrometer to calibrate the spectrometer. The radiative heater was an Infraquick heater (Infraquick: registered trademark) manufactured by NGK INSULATORS, Ltd., and the setting temperature was 600° C. Then, the above film was placed between the radiative heater and the external light-introducing unit, and the radiant intensity of radiant light that passed through the film was measured using the spectrometer. For comparison, the measurement was also performed without a film or using a PET (polyethylene terephthalate) film and a PI (polyimide) film. For the PET film, films having three thicknesses of 0.2 mm, 0.1 mm, and 0.03 mm were provided and measurement was performed. For the PI film, films having three thicknesses of 0.13 mm, 0.08 mm, and 0.03 mm were provided and measurement was performed. FIG. 12 to FIG. 15 illustrate the results. In the drawings, “No film” indicates the radiant intensity obtained using a radiative heater without a film, and the same curve is used in all of FIG. 12 to FIG. 15. The amount of infrared rays absorbed by the film is decreased as the radiant intensity comes close to that in the state of “No film”, which means that the film does not readily prevent infrared rays from reaching a processing object. As is clear from FIGS. 12 to 15, both the PTFE film and the PFA film tend to have a higher radiant intensity than the PET film and the PI film and can transmit infrared rays without absorbing the infrared rays so much. It is also found from FIGS. 12 and 13 that relatively strong absorption is observed in part of the wavelength range of 2 to 7 μm (the wavelength range of more than 3.7 μm and less than 4.4 μm) for the fluorine-based films (PTFE and PFA). In particular, when the thickness is 0.1 mm or 0.05 mm, the absorption is weak in the wavelength range of 2 to 7 μm. Consequently, a transmission equal to that in the state of “No film” is maintained. From the results in FIGS. 10 to 15, when PTFE or PFA is used for the inner tube, the thickness is believed to be preferably 0.1 mm or less and more preferably 0.05 mm or less. When the thickness of the inner tube is decreased, the strength of the inner tube may be increased by embossing the surface of the inner tube or employing a skeletal structure containing a fluorine-based material having a C—F bond for the inner tube to readily maintain the cylindrical shape of the inner tube. From the results in FIGS. 10 to 15, when PTFE or PFA is used for the inner tube, the peak wavelength of the maximum peak of infrared rays radiated from the metamaterial structure is believed to be preferably outside the wavelength range of more than 3.7 μm and less than 4.4 μm. In other words, the peak wavelength is believed to be preferably in the range of 2 μm or more and 3.7 μm or less or in the range of 4.4 μm or more and 7 μm or less.

In the above embodiment, the inner tube 40 contains a fluorine-based material having a C—F bond, but may contain calcium fluoride instead of the fluorine-based material. That is, the inner tube 40 may contain at least one of the fluorine-based material having a C—F bond and calcium fluoride. The calcium fluoride also has a relatively high transmittance of infrared rays in the wavelength range of 2 μm to 7 μm, and thus does not readily prevent infrared rays having a peak wavelength of the maximum peak and radiated from the metamaterial structure 30 from reaching a processing object. Therefore, the calcium fluoride is also suitable as a material for the inner tube 40. The inner tube 40 may contain calcium fluoride as a main component or may be constituted by calcium fluoride and unavoidable impurities. When calcium fluoride is used as a material for the inner tube 40, the inner tube 40 may have a thickness of, for example, 1 mm or more and 2 mm or less.

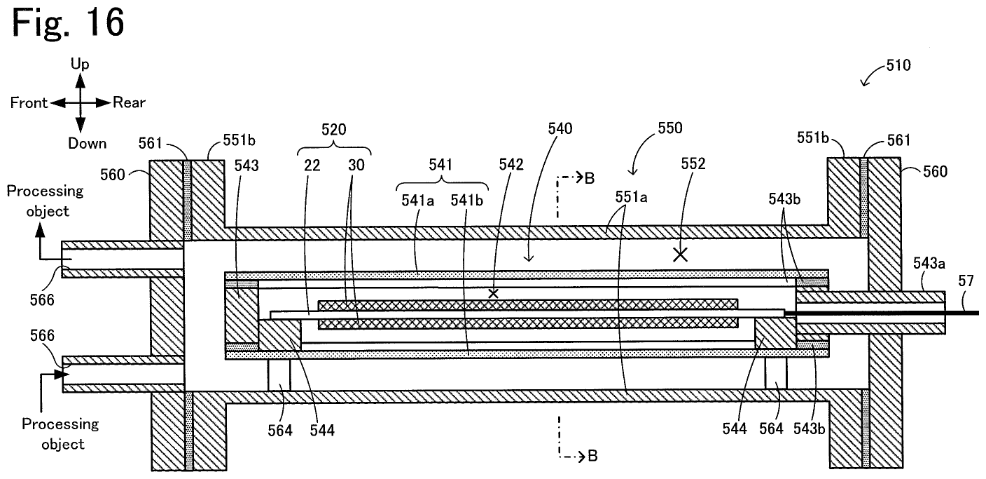

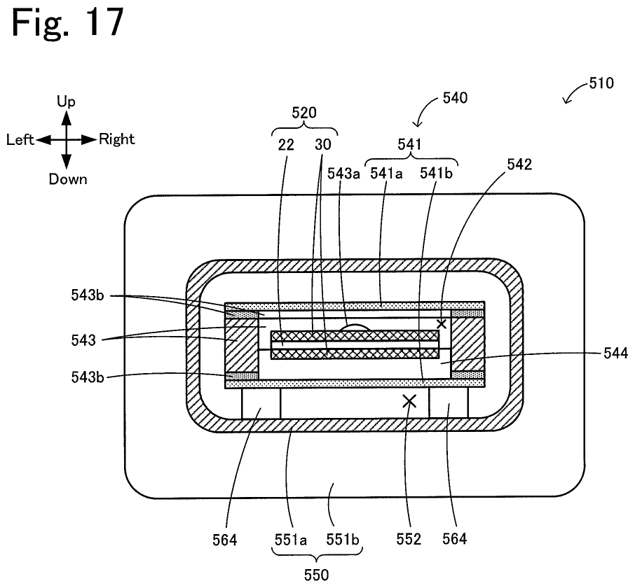

In the above embodiment, the inner tube 40 is a single member, but is not limited thereto. The inner tube 40 may be constituted by a plurality of members. In this case, all the plurality of members constituting the inner tube do not necessarily contain at least one of the fluorine-based material having a C—F bond and calcium fluoride, and some of members may contain at least one of the fluorine-based material having a C—F bond and calcium fluoride. FIG. 16 illustrates an infrared processing device 510 according to a modification. FIG. 17 is a sectional view taken along line B-B in FIG. 16. Hereafter, the infrared processing device 510 will be described.

The infrared processing device 510 includes an infrared heater 520, an inner tube 540 that surrounds the infrared heater 520, an outer tube 550 that surrounds the inner tube 540, and cap members 560 disposed at both ends of the outer tube 550 in the front and rear direction. The infrared heater 520 includes a heating unit 22, a metamaterial structure 30, and first and second supporting substrates 25a and 25b (not illustrated). As illustrated in FIG. 16, the infrared heater 520 is the same as the infrared heater 20, except that the heating unit 22 extends longer than the metamaterial structure 30 in the front and rear direction.

The inner tube 540 is a rectangular tubular-shaped member that surrounds the infrared heater 520 and includes an infrared transmitting member 541, a frame 543, and heater supporting members 544. The infrared transmitting member 541 includes a plate-shaped or film-shaped first infrared transmitting member 541a that serves as an upper surface of the inner tube 540 and a plate-shaped or film-shaped second infrared transmitting member 541b that serves as a lower surface of the inner tube 540. The first and second infrared transmitting members 541a and 541b contain at least one of a fluorine-based material having a C—F bond and calcium fluoride. Herein, the first and second infrared transmitting members 541a and 541b are each a plate-shaped member made of calcium fluoride. The thicknesses of the first and second infrared transmitting members 541a and 541b can be in the same range as those of the above-described inner tube 40. The frame 543 is a frame-shaped member including prisms serving as four sides of a quadrilateral in top view. The first and second infrared transmitting members 541a and 541b are attached to the upper surface and lower surface of the frame 543 with a gasket 543b and an adhesive material (not illustrated) interposed therebetween. The inner tube 540 has an internal space 542 surrounded by the infrared transmitting member 541 and the frame 543, and the infrared heater 520 is disposed in the internal space 542. The heater supporting members 544 attached inside the frame 543 are disposed in the internal space 542 at the front and rear of the internal space 542. By attaching the front end and rear end of the heating unit 22 to the heater supporting members 544, the infrared heater 520 is supported and fixed inside the inner tube 540. An electric wire extending pipe 543a is attached to the rear portion of the frame 543. A pair of electric wiring lines 57 (an electric wiring line 57 on the front end side is not illustrated) at both ends of the heating unit 22 are caused to extend from the internal space 542 to the outside through the electric wire extending pipe 543a.

The outer tube 550 is a rectangular tubular-shaped member that surrounds the inner tube 540. The outer tube 550 includes a rectangular tubular-shaped main body 551a and flanged members 551b disposed at both ends of the main body 551a in the front and rear direction. A plurality of (e.g., four) inner tube-supporting members 564 are disposed on the bottom portion of the main body 551a. The inner tube 540 is separated from the inner peripheral surface of the main body 551a by being disposed on the inner tube-supporting members 564. A space surrounded by the inner peripheral surface of the outer tube 550 and the outer peripheral surface of the inner tube 540 serves as an object channel 552.

The cap members 560 are disposed at both ends of the outer tube 550 in the front and rear direction so as to cover front and rear openings of the outer tube 550. A gasket 561 is disposed between the cap member 560 and the flanged member 551b, and the object channel 552 is sealed from the outside space using the cap member 560 and the gasket 561. The cap member 560 on the front side has object entrances 566. A processing object supplied from an object supply source (not illustrated) flows into the object channel 552 through the object entrance 566 on the lower side. The processing object that has flowed into the object channel 552 is subjected to infrared processing with infrared rays radiated from the infrared heater 520 and then flows out through the object entrance 566 on the upper side. The electric wire extending pipe 543a penetrates through the cap member 560 on the rear side in the front and rear direction. The infrared heater 520 and the inner tube 540 can be removed from the outer tube 550 by removing the cap member 560 from the outer tube 550. Thus, the infrared heater 520 and the inner tube 540 can be integrally exchanged, and the inner peripheral surface of the outer tube 550 and the surface of the inner tube 540 can be easily washed. The frame 543, the electric wire extending pipe 543a, the heater supporting members 544, the outer tube 550, the inner tube-supporting members 564, the cap members 560, and the object entrances 566 are each made of a material (herein quartz glass) that can transmit visible light. This allows an operator to readily observe the status inside the infrared processing device 510, such as the object channel 552 and the infrared heater 520. Herein, another material may be used for one or more of the members. For example, the outer tube 550 and the cap members 560 may be made of metal.

In the infrared processing device 510 having the above configuration, the infrared processing of a processing object can also be performed by applying infrared rays radiated from the infrared heater 520 to the processing object that flows through the object channel 552 as in the above embodiment. The infrared transmitting member 541 of the inner tube 540 does not readily prevent infrared rays having a wavelength near the maximum peak and radiated from the metamaterial structure 30 from reaching the processing object. Therefore, the infrared processing of the processing object can be efficiently performed.

The forms and modes of the above embodiment and the various modifications may be applied to the infrared processing device 510. For example, the main body 551a of the outer tube 550 may include a reflecting body on its inner peripheral surface or its outer peripheral surface. The pressure of the internal space 542 may be reducible. A transmission tube may be disposed between the outer tube 550 and the inner tube 540 to form a coolant channel between the inner tube 540 and the transmission tube. It suffices that the transmission tube also contains at least one of the fluorine-based material having a C—F bond and calcium fluoride. As in the case of the inner tube, all the plurality of members constituting the transmission tube do not necessarily contain at least one of the fluorine-based material having a C—F bond and calcium fluoride. For example, the transmission tube may include the same member as the infrared transmitting member 541 of the inner tube 540. The forms and modes described in the infrared processing device 510 may be applied to the above embodiment.

The above-described infrared processing device 510 was actually produced, and it was confirmed that the infrared processing of a processing object could be performed. In this infrared processing device 510, the heating body 23 was made of an Fe—Cr—Al—Co alloy, specifically, a Kanthal AF (Kanthal: registered trademark) manufactured by Sandvik. The first and second supporting substrates 25a and 25b were quartz plates having a thickness of 0.5 μm, and the peak wavelength of the maximum peak of infrared rays radiated from the metamaterial structure 30 was set to 5.88 μm. The first and second infrared transmitting members 541a and 541b were calcium fluoride plate-shaped members having a thickness of 1 mm. A circulation cooler was provided outside the object entrances 566 in a connected manner such that the processing object was circulated (repeatedly caused to flow through the object channel 552) while being cooled. To detect the overheating of the infrared transmitting member 541 caused when the infrared heater 520 generated heat while the object channel 552 was empty, an overheating detection sensor (not illustrated) was disposed on the infrared transmitting member 541. In this infrared processing device 510, an aqueous solution of a pharmaceutical raw material having an ether group was caused to flow, as a processing object, through the object channel 552 while power was applied to the heating body 23 and infrared rays were radiated from the metamaterial structure 30. As a result, it was confirmed that the infrared rays promoted the esterification reaction to generate benzoic acid in the processing object, which showed that the infrared processing was performed. Even when the materials for the first and second infrared transmitting members 541a and 541b were changed to a PFA film having a thickness of 0.1 mm, it was confirmed that the same infrared processing could be performed.

The present application claims priority from Japanese Patent Application No. 2017-131628 filed Jul. 5, 2017, the entire contents of which are incorporated herein by reference.

What is claimed is:

1. An infrared processing device comprising:
an infrared heater including a heating body and a metamaterial structure capable of, when thermal energy is input from the heating body, radiating infrared rays which have a maximum peak of a non-Planck distribution and whose maximum peak has a peak wavelength of 2 μm or more and 7 μm or less;
an inner tube that surrounds the infrared heater, contains at least one of a fluorine-based material having a C—F bond and calcium fluoride, and transmits infrared rays of the peak wavelength; and
an outer tube that surrounds the inner tube and forms, between the inner tube and the outer tube, an object channel through which a processing object is allowed to flow.

2. The infrared processing device according to claim 1,
wherein the fluorine-based material having a C—F bond is a fluorocarbon resin.

3. The infrared processing device according to claim 1, comprising:
a reflecting body that is disposed on an outer side of the outer tube with respect to the heating body and reflects infrared rays of the peak wavelength,
wherein the outer tube transmits infrared rays of the peak wavelength.

4. The infrared processing device according to claim 3,
wherein the reflecting body is disposed on an outer peripheral surface of the outer tube.

5. The infrared processing device according to claim 1,
wherein at least part of an inner peripheral surface of the outer tube is a reflecting surface that reflects infrared rays of the peak wavelength or the outer tube includes a reflecting body that reflects infrared rays of the peak wavelength on at least part of the inner peripheral surface.

6. The infrared processing device according to claim 1,
wherein in the inner tube, a pressure of an internal space in which the heating body is disposed is reducible.

7. The infrared processing device according to claim 1, comprising:
a transmission tube that is disposed inside the outer tube, surrounds the inner tube, contains at least one of a fluorine-based material having a C—F bond and calcium fluoride, and transmits infrared rays of the peak wavelength,
wherein the object channel is formed between the transmission tube and the outer tube, and
a coolant channel through which a coolant is allowed to flow is formed between the inner tube and the transmission tube.

8. The infrared processing device according to claim 1,
wherein the peak wavelength of the maximum peak is more than 3.5 μm and 7 μm or less.

9. The infrared processing device according to claim 1,
wherein the metamaterial structure includes, in sequence from the heating body, a first conductor layer, a dielectric layer joined to the first conductor layer, and a second conductor layer having a plurality of individual conductor layers that are each joined to the dielectric layer and are periodically disposed so as to be away from each other.
